(19) United States
(12) Patent Application Publication
(10) Pub. No.: US 2013/0040172 A1
(43) Pub. Date: Feb. 14, 2013

(54) STRUCTURE OF LITHIUM-ION BATTERY MODULE

(71) Applicants: Guangsen Chen, Foshan (CN); Qun Ai, Foshan (CN); Jianqing Zhou, Foshan (CN); Weijin Wu, Foshan (CN)

(72) Inventors: Guangsen Chen, Foshan (CN); Qun Ai, Foshan (CN); Jianqing Zhou, Foshan (CN); Weijin Wu, Foshan (CN)

(73) Assignee: Advanced Electronics Energy Limited, Foshan (CN)

(21) Appl. No.: 13/295,276

(22) Filed: Nov. 14, 2011

(30) Foreign Application Priority Data
Aug. 8, 2011 (CN) 201120287926.5

(51) Int. Cl. H01M 2/10; H01M 2/12

(52) U.S. Cl. 429/53; 429/82

(57) ABSTRACT

A structure of lithium-ion battery module comprises a battery case, containing one or more flexible packaging polymer lithium-ion battery cells, at of which top a connecting conductor is arranged to connect them in series and/or parallel to form a battery pack, positive and negative poles of the battery pack are mounted on the connecting conductor. The structure further comprises a battery cover plate welded on the open end of the battery case to package the battery pack into the battery case, and the positive and negative pole terminals of the battery module are arranged on the battery cover plate and welded to the positive and negative poles. The plate is provided with one or more through hole, through which the air in the battery case is evacuated and the inert gas is injected, after that a steel ball is clamped into each through hole to seal the battery case.

### CROSS-REFERENCE TO RELATED APPLICATION

The present application claims priority from Chinese Patent Application No. 201120287926.5 filed on Aug. 8, 2011, the content of which is hereby incorporated by reference into this application.

### Technical Field

The present invention relates to a lithium-ion battery module, and more particularly to a structure of lithium-ion battery module.

### Background Information

At present, the lithium batteries on the market could be divided into several kinds according to the packaging materials thereof: aluminum case lithium-ion batteries, steel case lithium-ion batteries, and polymer lithium-ion batteries and so on. Wherein, the aluminum/steel case lithium-ion batteries have the advantages as: the batteries have great structural strength, easy to assemble, but having weaker malleability compared with the polymer lithium-ion batteries, and because of the great structural strength, it is difficult for the battery to release the gas within, thus easy to result in safety accidents such as explosion. The polymer lithium-ion batteries are characterized in that: flexible design, better safety performance, better heat conduction, wider applicable temperature range, higher discharge current and so on; however, as their outer packing is a packing film, which is easily pierced through under an external force; furthermore, as the plate lugs are sheet-shaped, the assembly and connection of the soft plate lugs to the battery body are not easy.

A lithium-ion power battery popular on the market usually consists of several high-capacity battery units connected in series-parallel, this assembly approach has the following drawbacks: 1. the costs of replacement or production could be high once there are problems in use or production control; 2. The batteries have large sizes because their large capacities, the temperature differences among different positions of a battery are great, heat generated is difficult to dissipate, resulting in heat accumulation; 3. As the great capacity, while seeking to satisfy different requirements, the modules of a same size could not be universally compatible, namely more modules with different sizes for different requirements are needed, resulting in the increasing intangible costs of development.

### SUMMARY OF THE INVENTION

In order to overcome the drawbacks of the existing technologies, the present invention provides a structure for lithium-ion battery modules with reasonable design, better safety performance, better heat dissipation performance, longer service lifetime, simply but reliable connectivity, and flexibility.

In the present invention, the technical solution adopted to solve the technical problem is:

A structure of lithium-ion battery module, comprising: a battery case; one or more flexible packaging polymer lithium battery cells contained by the battery case; a connecting conductor, mounted on the top of the flexible packaging polymer lithium battery cells to connect the flexible packaging polymer lithium battery cells in series and/or parallel together to form a lithium battery pack; positive and negative poles, arranged on the connecting conductor; a battery cover plate, welded on the open end of the battery case to package the polymer lithium battery cells within the battery case; positive and negative pole terminals, arranged on the battery cover plate and welded to the positive and negative poles; wherein the battery cover plate is provided with one or more through-holes, through which the air in the battery case is evacuated and the inert gas is injected into the battery case, after that a steel ball is embedded in each through-hole to seal the battery module.

The structure further comprises an anti-explosion valve arranged in the battery cover plate.

The structure further comprises a voltage probe arranged in the battery cover plate.

Wherein, the lithium battery pack consisting of one or more flexible packaging polymer lithium battery cells is clamped in the battery case, and an insulation sleeve is arranged on the upper part of the lithium battery pack.

As in the present invention, the flexible packaging polymer lithium-ion battery cells 1 and a double sealing structure of the battery case 5 are adopted, the strength of the entire module is significantly enhanced, hereby preventing the battery module from the problems of performance degradation or discard caused by package breaking in corners or other positions, and thus the yield is improved. Furthermore, the module consists of one or more flexible packaging polymer lithium-ion battery cells within, which could be connected in series, parallel, or series-parallel, hereby providing flexibility in assembly. In addition, the modules of a same size could have various configurations, facilitating the generalization of module standardization. In addition to above, after long term use, it is difficult for the conventional lithium-ion batteries/modules, produced by direct injection of the electrolyte into the conventional aluminum/steel cases, to prevent the infiltration of water, thus resulting in performance degradation and discard finally, and failure to achieve the service lifetime expected. Instead, the battery module according to the present invention is full of inert gas and has no air inside, and contains the battery pack consisting of the flexible packaging polymer lithium-ion battery cells; the double seal of the present invention could effectively and significantly improve the safety performance and service lifetime of the battery module. In the present invention, in the battery cover plate 5, an anti-explosion valve 9 is provide, which could be opened under the pressure between 2-3 kg to release the pressure, whereby the safety performance of the battery is significantly improved, and the possibility of explosion caused by excessive pressure is eliminated.

### BRIEF DESCRIPTION OF DRAWINGS

FIG. 1 is a schematic view of the present invention;

FIG. 2 is a part sectional view of the present invention;

FIG. 3 is an exploded view of the present invention; and

FIG. 4 is a schematic view of the present invention with a voltage probe.

### DETAILED DESCRIPTION OF THE PREFERRED EMBODIMENTS

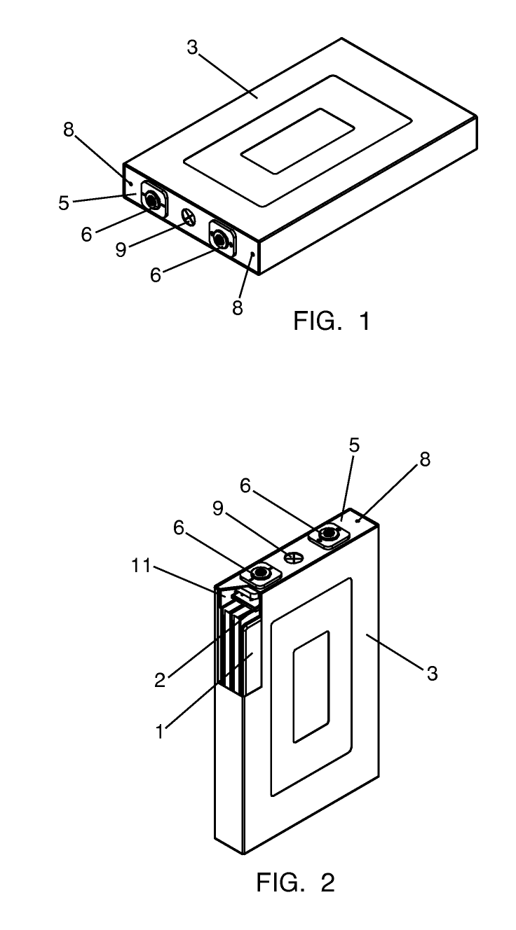

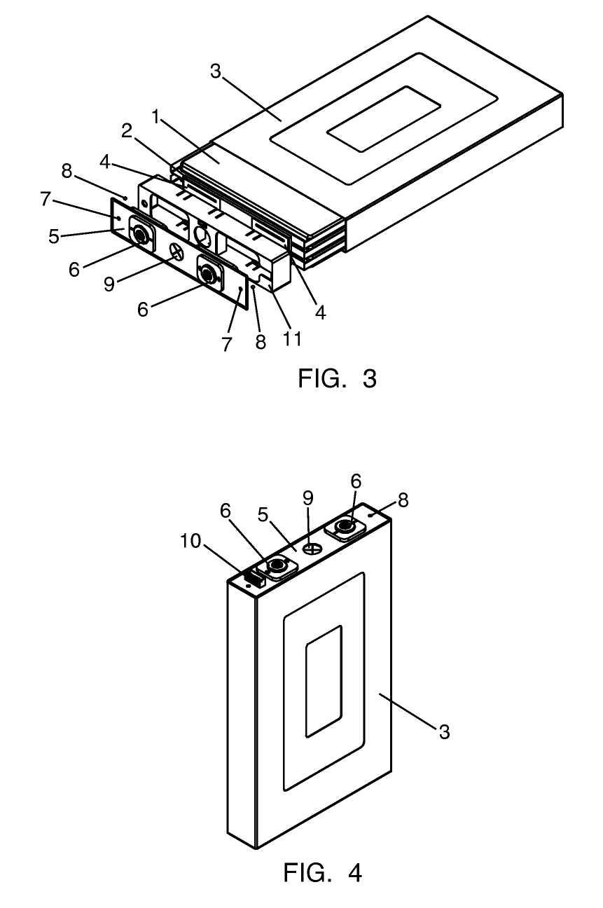

As shown by FIGS. 1, 2 and 3, the structure of lithium-ion battery module according to the present invention comprises a battery case 3, which contains a plurality of flexible packaging polymer lithium-ion battery cells 1, on of which top a connecting conductor 2 is mounted to connect those cells together in series and/or parallel to form a lithium-ion battery pack, and the positive and negative poles 4 of the battery pack are arranged on the connecting conductor 2 as well, a battery cover plate 5 is welded on the open end of the battery case 3 so as to package the flexible packaging polymer lithium-ion battery cells 1 within the battery case 3, and the positive and negative poles 4 of the battery pack are welded to the positive and negative pole terminals 6 arranged on the battery cover plate 5, two through-holes 7 are provided in the battery case 5, the air in the battery case 3 is evacuated through these through-holes 7, and a steel ball 8 is embedded into each through-hole 7 to seal the battery case 3.

Wherein, the flexible packaging polymer lithium-ion battery cells 1 are already sealed and have great performance.

As in the present invention, the flexible packaging polymer lithium-ion battery cells 1 and a double sealing structure of the battery case 5 are adopted, the strength of the entire module is significantly enhanced, hereby preventing the battery module from the problems of performance degradation or discard caused by package breaking in corners or other positions, and thus the yield is improved. Furthermore, the module consists of several flexible packaging polymer lithium-ion battery cells 1 within, which could be connected in series, parallel, or series-parallel, hereby providing flexibility in assembly. In addition, the modules of a same size could have various configurations, facilitating the generalization of module standardization, and thus saving a great deal of cost in development. In addition to above, after long term use, it is difficult for the conventional lithium-ion batteries/modules produced by direct injection of the electrolyte into the conventional aluminum/steel cases to prevent the infiltration of water, this results in performance degradation and discard finally, and failure to achieve the service lifetime expected. Instead, the battery module according to the present invention is full of inert gas and has no air inside, the contains the battery pack consisting of the flexible packaging polymer lithium-ion battery cells, the double seal of the present invention could effectively and significantly improve the safety performance and service lifetime of the battery module. In the present invention, in the battery cover plate 5, an anti-explosion valve 9 is provide, which could be opened under the pressure between 2-3 kg to release the pressure, whereby the safety performance of the battery is significantly improved, and the possibility of explosion caused by excessive pressure is eliminated.

In the present invention, a voltage probe 10 is provided in the battery cover plate 5, whereby the battery module could be connected to the protection board or management system directly, to achieve voltage sampling and monitoring, and the operation is easy and convenient.

In the present invention, the battery pack consisting of the flexible packaging polymer lithium-ion battery cells 1 is clamped within the battery case 3, and on the upper part of the lithium battery pack an insulation sleeve is arranged; as the internal battery cells are directly in contact with the aluminum or steel made battery case 3, the battery module has great heat conduction and dissipation performance; the aluminum or steel made battery cover plate 5 is designed with two terminals to lead out the positive and negative poles 4 of the battery pack, the assembly is simple and reliable, and the safety and service lifetime are improved significantly. The insulation sleeve 11 provided could effectively prevent the potential safety hazards such as short circuit caused by the contact between the positive and negative poles of the battery pack and the battery case 3 from happening.

The structure of lithium-ion battery module disclosed in the present invention has a reasonable structural design, enhanced safety performance, better heat dissipation, longer service lifetime, and simple but reliable and flexible connection; it could be widely adopted in the lithium-ion battery production.

While the present invention has been illustrated and described with respect to a particular embodiment thereof, it should be appreciated by those of ordinary skill in the art that various modifications to this invention may be made without departing from the spirit and scope of the present.

What is claimed is:

1. A structure of lithium-ion battery module, comprising:
a battery case;
one or more flexible packaging polymer lithium battery cells contained by the battery case;
a connecting conductor, mounted on the top of the flexible packaging polymer lithium battery cells to connect the flexible packaging polymer lithium battery cells in series and/or parallel together to form a lithium battery pack;
positive and negative poles, arranged on the connecting conductor;
a battery cover plate, welded on the open end of the battery case to package the polymer lithium battery cells within the battery case;
positive and negative pole terminals, arranged on the battery cover plate and welded to the positive and negative poles;
wherein, the battery cover plate is provided with one or more through-holes, through which the air in the battery case is evacuated and the inert gas is injected into the battery case, after that a steel ball is embedded in each through-hole to seal the battery module.

2. The structure of lithium-ion battery module according to claim 1, further comprising an anti-explosion valve arranged in the battery cover plate.

3. The structure of lithium-ion battery module according to claim 1, further comprising a voltage probe arranged in the battery cover plate.

4. The structure of lithium-ion battery module according to claim 1, wherein the lithium battery pack consisting of one or more flexible packaging polymer lithium battery cells is clamped in the battery case, and the structure further comprises an insulation sleeve arranged on the upper part of the lithium battery pack.
